(19) United States
(12) Patent Application Publication
(10) Pub. No.: US 2019/0230904 A1
(43) Pub. Date: Aug. 1, 2019

(54) DEVICE PRODUCING SOUND WHEN LEASH TAUTNESS IS REDUCED

(71) Applicant: Kyra Sundance, Lancaster, CA (US)

(72) Inventor: Kyra Sundance, Lancaster, CA (US)

(73) Assignee: Kyra Sundance, Lancaster, CA (US)

(21) Appl. No.: 16/377,753

(22) Filed: Apr. 8, 2019

Related U.S. Application Data
(63) Continuation of application No. PCT/US2016/056265, filed on Oct. 10, 2016.

(51) Int. Cl. A01K 27/00; A01K 15/02; G01L 5/04; G08B 21/18

(52) U.S. Cl. CPC A01K 27/009; A01K 15/021; G08B 21/182; G01L 5/04; A01K 27/003

(57) ABSTRACT

An animal training device for use by a handler training an animal is shown. The animal training device includes a tension measurement device for measuring the tension on a leash between the handler and the animal. The animal training device also includes a sound generator that is able to produce sound. The tension measurement device takes a first tension measurement and a second tension measurement after the first measurement. The sound generator produces a sound when the second tension measurement is less than the first tension measurement.

### CROSS REFERENCE TO RELATED APPLICATIONS

This application is a continuation of International Patent Application No. PCT/US2016/056265, filed Oct. 10, 2016 all of which is hereby incorporated by reference.

### BACKGROUND

When an owner is walking or running with their pet, it is common for the pet to be hooked to a leash so that the owner can keep the pet at a short distance. However, oftentimes, the pet wants to move faster or move in a different direction than their owner, resulting in the pet pulling or tugging on the leash; a result that the pet owner may not desire.

Prior art devices such as a harness, a head halter, a prong collar, or a choke chain may be used as management tools that immediately dissuade the pet from pulling by causing discomfort or pain when the animal pulls. When the management tool is no longer used, the animal may revert to pulling behavior.

Ideally a training program focuses teaching the animal to repeat a desired behavior by clearly and consistently informing the animal of the desired behavior, allowing the animal to choose his action by free will, and reinforcing that choice with either a reward or a denial of a reward.

Verbal feedback may be used to inform the animal of when his leash behavior is correct or incorrect. When administered verbally or manually, auditory signals may not be as precise or consistent as is optimal.

Therefore, a device would be beneficial that would automatically emit a short auditory marker when leash tension is relaxed (to indicate correct leash slackness) and a different short auditory marker when leash tension is in increased (to indicate incorrect pulling behavior)

### SUMMARY

An animal training device for use by a handler, which produces a positive sound which indicates the instant associated with the desired condition of having leash tension go slack.

The animal training device includes a tension measurement device that is configured to measure the tension generated on a leash between the handler and the animal. The animal training device also includes a sound generator that is able to produce at least a first sound. In some embodiments, the animal training device is positioned between a leash and the animal. In other embodiments, the animal training device is integral with the leash or integral with a collar that is put on the animal.

The tension measurement device is configured to take a first tension measurement. A second tension measurement is taken at a time after taking the first tension measurement. If the second tension measurement is less than the first tension measurement, then the sound generator produces the first sound. The first sound may be a recording of the handler's voice praising the animal.

In some embodiments, the tension measurement device may be configured to take an intermediate tension measurement between taking the first tension measurement and second tension measurement. In this embodiment, the sound generator produces the first sound only if both the intermediate tension measurement and the second tension measurement are less than the first tension measurement. In other embodiments, there are more complex determinations of when the sound generator produces the first sound that take into account multiple measurements at different times before producing a first sound associated with desired behavior.

In another embodiment, the sound generator is also able to produce a second sound. If the second tension measurement is less than the first tension measurement, then the sound generator produces the first sound. Preferably, the first sound is a positive sound that the animal associates with a history of being rewarded. However, if the second tension measurement is greater than the first tension measurement, the sound generator produces the second sound. Preferably, the second sound is a negative sound that the animal associates with a history of being denied a reward.

Other embodiments include a first tension threshold level and optionally a second threshold tension level. In these embodiments, when the second tension measurement is less than the first tension measurement and the second tension measurement is less than the first threshold tension level then the sound generator produces the first sound. Likewise, if the second tension measurement is greater than the second tension measurement and the second tension measurement is greater than the second threshold tension level then the sound generator produces the second sound.

There are many ways of implementing the concepts being claimed that are more sophisticated than illustrated herein, such as including automatically adjusting thresholds to adapt over time to various size animals, and/or using more complex hysteresis analytics with different thresholds for increasing tension than for decreasing tension. However, for purposes of illustration, the simpler descriptions herein are provided for clarity and understanding of the scope of what is being claimed.

### BRIEF DESCRIPTION OF THE DRAWINGS

FIG. 1 is a view of a handler and an animal with an animal training device between a leash and the animal's collar for use by the handler in training the animal.

FIG. 2 is a schematic drawing of the animal training device of FIG. 1.

FIG. 3 is an embodiment of an animal training device of FIG. 1 that is integral with a leash.

FIG. 4 is an embodiment of an animal training device of FIG. 1 that is integral with a collar.

FIG. 5 is a flowchart for training an animal using the animal training device of FIG. 1.

FIG. 6 is a flowchart for training an animal using the animal training device of FIG. 1.

FIG. 7 is a flowchart for training an animal using the animal training device of FIG. 1.

### DESCRIPTION OF PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

In this description, the terms “positive sound” and “negative sound” are used to describe different sounds that may be used in conjunction with the animal training device. A positive sound is any noise that an animal learns to associate with a reward. Since there may be a lag time between the time the animal performs a desired behavior and his receipt of a reward, the “positive sound” acts as a marker to precisely pinpoint for him the instance he succeeded in earning a reward. Clickers used to train dogs are an example of this same use of a “reward marker” positive sound marking the time of success. A recording of a trainer's voice saying “yes” is a positive sound. A negative sound is any noise that the animal learns to associate with the denial of a reward. As an example, a buzz, may be a negative sound. A recording of a trainer's voice saying “no” is a negative sound.

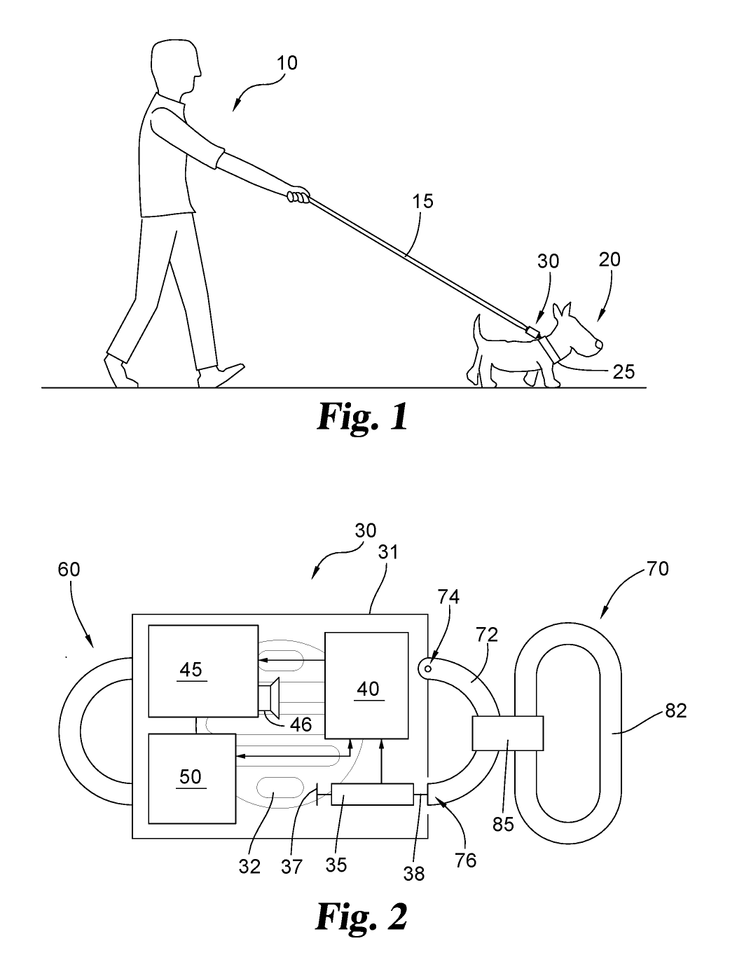

FIG. 1 illustrates a handler 10 and an animal 20. The handler 10 holds a leash 15 that is coupled to the animal 20 through an animal training device 30 and collar 25. In this embodiment an animal training device 30 is positioned between leash 15 and collar 25.

FIG. 2 shows a schematic diagram of the embodiment of animal training device 30 of FIG. 1. Animal training device 30 includes a housing 31 that encloses a tension measurement device, such as a load cell 35; a computing device 40; a sound generator, such as sound module 45 with a speaker 46 adjacent a grill 32; and a Bluetooth module 50. It is conventionally supplied with battery power not separately shown. Connection members 60, 70 are positioned on respective sides of housing 31. In the embodiment of FIG. 1, connection members 60 is configured to attach to the apparatus held by the handler 10, such as leash 15 and the other of connection members 70 is configured to attach to the animal 20 at collar 25. The positions of connection members 60 and 70 could be reversed if desired.

The tension measurement device 35 may be any device that is able to measure the force that is applied to the leash between the handler 10 and animal 20. As an example, a load cell 35 may be used to translate the measurement of a force into an electrical signal. Load cell 35 may operate using a strain gauge, piezoelectric material, hydraulics, spring and variable resistor combination, pneumatics, or any other suitable method for measuring force. Load cell 35 is electrically connected to computing device 40 so that the force measurements measured by load cell 35 may be delivered to computing device 40.

In FIG. 2 load cell 35 has a reference end 37 mounted within housing 31 of animal training device 30. A measurement end 38 of load cell is attached to connection member 70 that includes a housing attachment 72 and an animal attachment 82 coupled to each other by a linking member 85. Housing attachment 72 pivots at one end about pin 74 that is fixed to housing 31 and couples at its other end at 76 to the measurement end 38 of load cell 35. When animal attachment 82 is attached to an animal 20, tension may be applied to animal training device 30 by movement of the animal 20 relative to the handler 10. As the animal 20 applies tension or decreases tension, connection member 70 pivots about pin 74, so that end portion 76 is either pulled away from housing 31 or pushed toward housing 31. Because end portion 76 is attached to measurement end 38 of load cell 35, the movement of end portion 76 affects the position of measurement end 38, allowing load cell 35 to measure the tension created by animal 20.

Other embodiments may have alternative methods of measuring tension using load cell 35. For example, connection member 70 may include a single, straight slidable piece that connects to measurement end 38 of load cell 35 and extends from housing 31. Connection member 70 may include a loop attached to the slidable piece that may be connected to the animal 20. Tension applied by the animal 20 is transferred to the slidable piece that connects to load cell 35, and the slidable piece slides relative to housing 31. In other embodiments, any other suitable arrangement that allows load cell to measure the tension generated on the leash 15 between the handler 10 and the animal 20 may be used.

Computing device 40 is also electrically connected to sound module 45, which has a speaker 46. Sound module 45 may be any device that is able to generate sound, such as from audio signals generated by computing device 40 or computing device 40 may simply send a signal to sound module 45 instructing sound module 45 to produce a particular sound through its speaker 46 mounted adjacent grill 32 in housing 31. In some embodiments, sound module 45 may be limited to producing a single sound; however, in other embodiments, sound module 45 may be able to produce a variety of sounds.

Animal training device 30 may also include a Bluetooth module 50 that is operationally connected to computing device 40. Bluetooth module 50 allows a user to wirelessly communicate with computing device 40 to set desired parameters and settings for the operation of animal training device 30. In other embodiments, animal training device 30 may include other communication alternatives, such as a USB port.

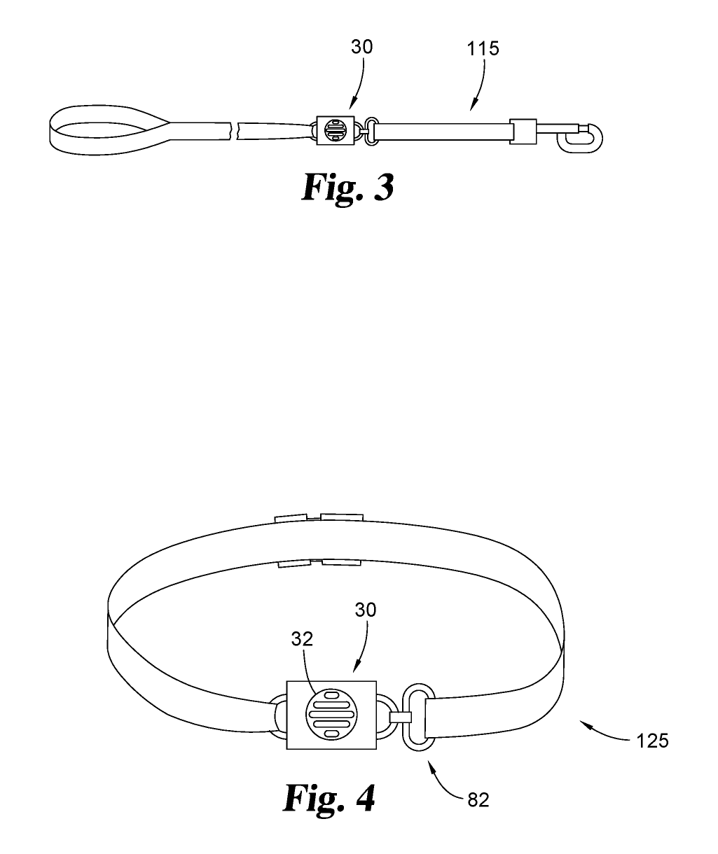

Although the animal training device 30 shown in FIG. 1 is attached between the end of leash 15 and collar 25, in other embodiments, animal training device 30 may be positioned at other places between handler 10 and animal 20. As shown in FIG. 3, animal training device 30 may be integral to a leash 115. Leash 115 may be attached to the collar of an animal 20 and tension between the handler 10 and the animal 20 may be measured along leash 115. Alternatively as shown in FIG. 4, animal training device 30 may be integral to a collar 125. Collar 125 may be positioned on an animal 20 with a leash coupled to animal attachment 82 so that tension between the handler 10 and animal 20 may be measured at the collar 125.

In use, animal training device 30 is configured to be used by a handler training an animal to not pull on a leash while walking. Animal training device 30 may be programmable to produce sounds that, by previous association with the receipt of or denial of a reward, either encourage or discourage the animal's behavior in order to teach the animal how to walk while maintaining a slack leash. In some instances, animal training device 30 may use hysteresis when determining whether a sound should be produced or whether the sound should not be produced. Hysteresis takes into account the past states of the system so that animal training device 30 may reward the animal not just when the tension on the leash is below a certain value, but also when the animal is reducing tension from a higher tension level. Hysteresis can also use a different threshold for when tension is decreasing (warranting a pleasant sound) than it uses when tension is increasing (warranting an unpleasant sound).

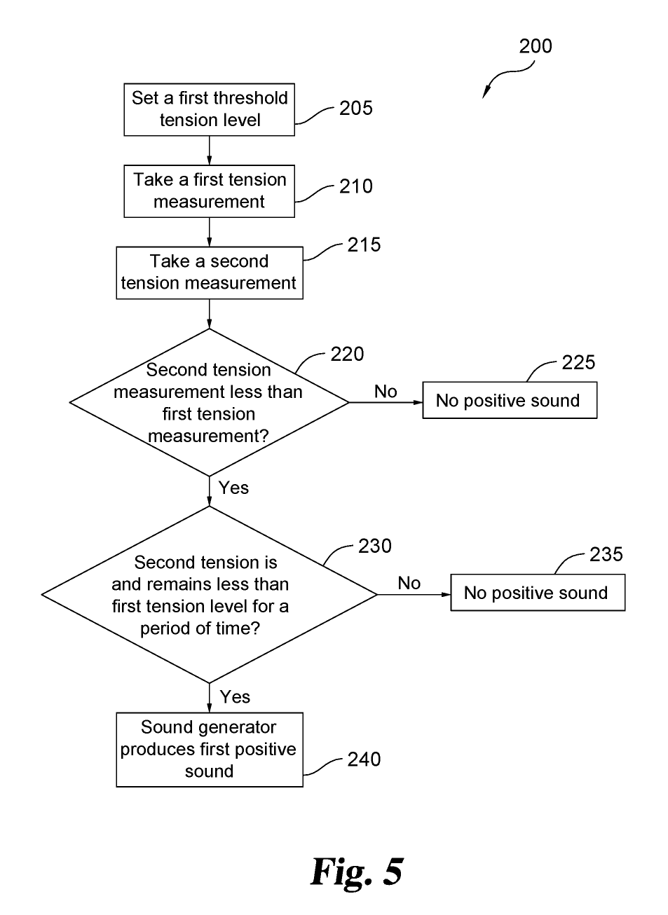

FIG. 5 shows a flowchart 200 for training an animal using the animal training device shown in FIG. 1 by providing a positive reinforcement signal when the animal reduces tension on a leash. The positive reinforcement signal is provided in the form of a sound that is pleasing to the animal because it has a history of being associated with a reward. Preferably the first sound lasts only from 0.1 to 10 seconds, and more preferably from 0.2 to 3 seconds, and ends thereafter until another reduction from an excessive tension is sensed. The sound may be speech, such as “good dog,” that can be the trainer's own voice downloaded wirelessly through Bluetooth module 50.

Animal training device 30 is positioned between the handler and the animal, for example between a leash and a collar. The tension measurement device, such as a load cell, measures the tension generated on the leash between the handler and the animal. In a first step 205, the handler may set a first threshold tension level that is programmed into the computing device 40 of the animal training device 30. While the handler is walking with the animal on a leash, the animal training device takes a first tension measurement 210. Then, after a period of time, the animal training device takes a second tension measurement 215. The time between the first tension measurement and the second tension measurement may be preprogrammed into the animal training device 30 or may be adjustable and determined by the handler.

The animal training device then determines whether the second tension measurement is less than the first tension measurement 220. If the second tension measurement is not less than the first tension measurement, indicating that the animal is pulling as hard or harder on the leash, then no positive sound 225 is made by the animal training device.

If the second tension measurement is less than the first tension measurement, this indicates that the animal is not applying as much tension to the leash. The second tension measurement is then compared 230 to the first threshold tension level set in step 205. If the second tension measurement does not remain less than the first threshold tension level for a period of time, then no positive sound is produced. In this example, if the tension remains below the first tension measurement and below the first threshold tension level for the given period of time, the sound generator produces a first sound 240. In the preferred embodiment, this first sound is a positive sound that the animal finds pleasing, so that the first sound reinforces the reduction of tension on the leash between the handler and the animal.

In this embodiment, the second tension measurement may be required to remain below the first threshold level during the time delay before the sound module produces the first sound. In other embodiments, the second tension measurement may be required to be below the first threshold level for some other adjustable period of time before the first sound is produced.

In some embodiments, having a first threshold tension level is optional, or it is adaptive to change based upon prior tension levels measured. In the embodiments where there is no threshold level, the animal training device 30 takes a first tension measurement 210 and then takes a second tension measurement 215 at some time after the first tension measurement. If the second tension measurement is less than the first tension measurement 220, then the sound generator produces a first sound 240. In some embodiments, the second tension measurement must remain below the first tension measurement for a period of time before the sound generator produces the first sound 240. If the second tension measurement is greater than the first tension measurement, indicating that the tension between the handler and the animal has increased, then no sound is made.

The optional period of time before the sound generator produces the first sound is a time delay that is greater than the time that it takes for the electrical signal to be received by the computing device by the load cell, and then for the computing device to send a signal to the sound module to produce a first sound. As an example, the time delay could be 0.1 seconds, 0.5 second, 3 seconds, 10 seconds or any other desired time. In some embodiments, the time delay may be controlled and adjusted by a user, for example using a personal computer, smartphone or tablet to wirelessly communicate with the computing device 40 via the Bluetooth module 50 in the animal training device 30. In other embodiments, the time delay may be preprogrammed into the computing device. This time delay can be used so that the first sound is not produced continuously as the tension in the leash is reduced. Instead, the animal receives intermittent rewards for good behavior.

The threshold tension level may be used to ensure that positive reinforcement is provided to the animal only after the tension on the leash has been reduced to a certain level. This prohibits the sound from being made when the animal has reduced tension on the leash from a previous level, but the tension on the leash is still considered to be unacceptable. In some embodiments, the threshold tension level may be adjustable, allowing the animal training device 30 to be used for different sized animals. A certain threshold tension level that may be acceptable for bigger animals may be unacceptable for smaller animals. The threshold tension level may be programmable so that a user may use a personal computer, smartphone or tablet device to set a desired threshold by communicating with the Bluetooth module 50 in the animal training device 30. In other embodiments, the threshold tension level may automatically adjust based on the calculation of several tension measurements from the tension measurement device. As an example, the tension measurement device may take tension measurements over a period of several hours and then adjust the threshold tension level as a certain percentage of the peak tension measured over that time period. Other calculations based on tension measurements may also be used to set a threshold tension level.

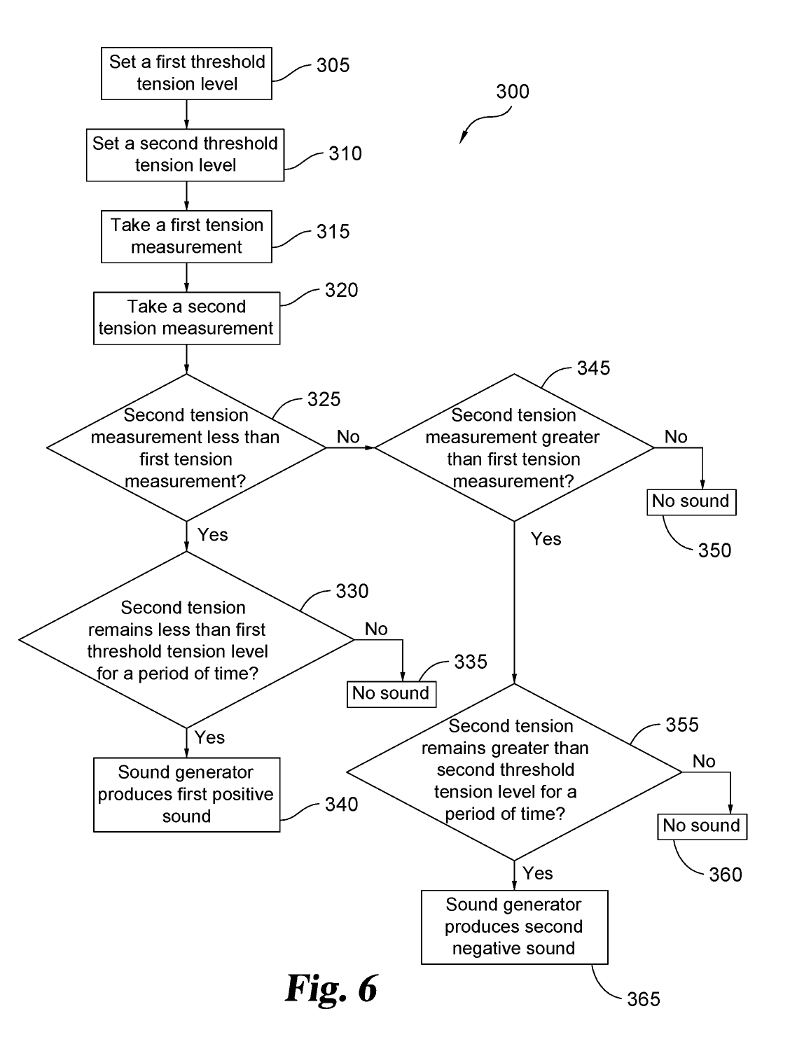

FIG. 6 illustrates a flowchart 300 for training an animal using the animal training device of FIG. 1 by providing positive feedback when the animal reduces tension on a leash and by providing negative feedback when the animal increases tension a leash. Flowchart 300 begins with the optional steps of setting a first threshold tension level 305, and setting a second threshold tension level 310. The first threshold tension level should be a set at a lower tension than the second threshold tension level. A first tension measurement is taken 315 by the tension measurement device, and a second tension measurement is taken 320 at some time after the first tension measurement.

The first and second tension measurements are compared to determine whether the second tension measurement is less than the first tension measurement 325. If the second tension measurement is less than the first tension measurement, this indicates that the animal has reduced the tension on the leash. If an optional first threshold level was set, then the second tension measurement is compared to the first threshold tension level 330. If the second tension measurement is not less than the first threshold tension level, then no sound is produced 335. However if the second tension measurement is less than the first threshold tension level for a period of time, then the sound module produces a first sound 340. Preferably, the first sound is a positive sound that reinforces the animal's behavior of reducing the tension in the leash. It could be a harmonic sound or a click.

If the second tension measurement is not less than the first tension measurement in step 325, then it is determined whether the second tension measurement is greater than the first tension measurement 345, indicating that the tension on the leash has increased. If the second tension measurement is not greater than the first tension measurement, then no sound is produced 350. However, if the second tension measurement is greater than the first tension measurement, then it is determined whether the second tension measurement is greater than the second threshold tension level 355. If the second tension measurement is not greater than the second threshold tension level, the no sound is made 360. If the second tension measurement is greater than the second threshold tension level for a period of time, the sound generator produces a second sound 365 that is different than the first sound produced in step 340. Preferably, the second sound is a negative sound that encourages the animal to stop pulling on the leash. As examples, the second sound could be from a recording of the handler harshly saying “no,” or it could be a loud, dissonant sound that is aversive to the animal.

Similar to the first threshold level, for some embodiments, the second tension measurement must remain above the second threshold tension level for a predetermined amount of time before the sound generator produces the second sound. Therefore, if the tension in the leash has increased, but the tension level is still acceptable, the animal will not be negatively signaled with the second sound. This predetermined amount of time may be adjustable.

Similar to flowchart 200 shown in FIG. 5, the threshold tension levels and the time delays in flowchart 300 are optional. In some embodiments, the animal training device may take a first tension measurement and then take a second tension measurement at a time after the first tension measurement. The second tension measurement is then compared to the first tension measurement. If the second tension measurement is less than the first tension measurement, then the sound module produces a first sound. In some embodiments, the second tension measurement may be required to remain below the first tension measurement for a period of time before the first sound is produced. The first sound may be a positive sound that the animal finds pleasing and that reinforces the reduction in tension on the leash. If the second tension measurement is greater than the first tension measurement, then the sound module produces a second sound. In some embodiments, the second tension measurement may be required to remain greater the first tension measurement for a period of time before the second sound is produced. The second sound may be a negative sound that the animal finds to be displeasing and discourages the animal from increasing the tension on the leash.

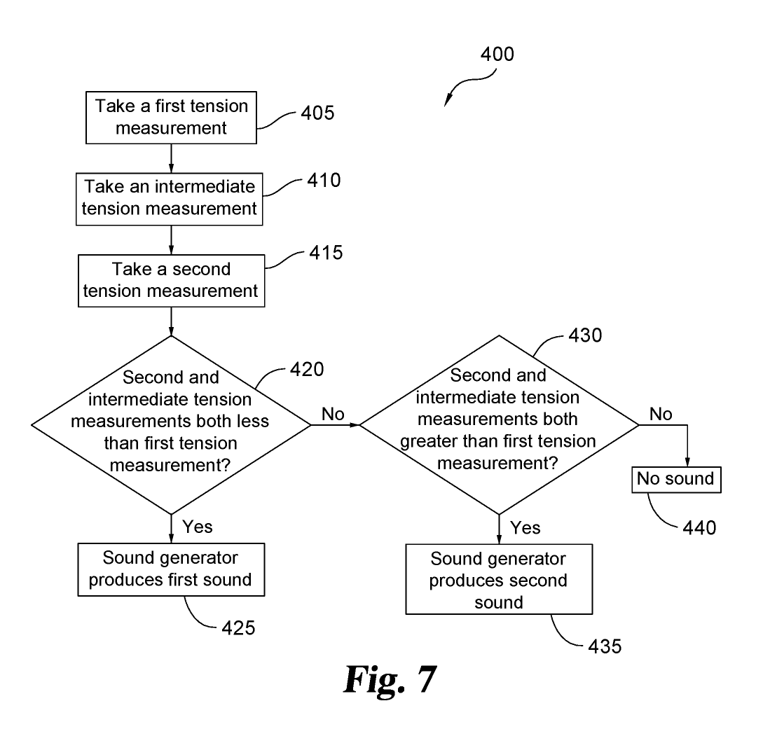

FIG. 7 shows a flowchart 400 that shows another embodiment for training an animal using the animal training device of FIG. 1. In this embodiment, the animal training device takes a first tension measurement 405. An intermediate tension measurement is taken 410 at a time after the first tension measurement. Then a second tension measurement is taken 415 after both the first tension measurement and the second tension measurement.

The intermediate tension measurement and the second tension measurement are then compared to the first tension measurement. If the both the second tension and the intermediate tension are less than the first tension 420, then the sound module produces a first sound 425. Preferably, the first sound is a positive sound that the animal finds pleasing and reinforces the animal to reduce the tension on the leash. However, if the second and intermediate tensions are not both less than the first tension measurement, it is determined whether the second tension and the intermediate tension are both greater than the first tension 430. If the second and intermediate tensions are greater than the first tension, the sound module produces a second sound 435. Preferably, the second sound is a negative sound that the animal finds displeasing and discourages the animal to increasing the tension on the leash. If the intermediate tension and the second tension are neither both greater than nor both less than the first tension, then no sound is produced 440.

The purpose of the intermediate tension measurement in flowchart 400 is to prevent the animal from being rewarded with the first sound when the animal is rapidly moving back and forth between a higher tension and a lower tension. Instead, in order to be rewarded with the first sound, the animal must show a sustained reduction in the tension on the leash. Likewise, by requiring both the intermediate and second tensions to be higher than the first tension for the second sound, the animal is not negatively signaled for brief periods of higher tension.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected.

1. An animal training device for use by a handler training an animal comprising:
a tension measurement device configured to measure the tension generated on a leash between the handler and the animal;
a sound generator, wherein said sound generator is able to produce a first sound;
wherein said tension measurement device is configured to take a first tension measurement and a second tension measurement, and wherein said second tension measurement is taken after said first tension measurement; and,
wherein said sound generator is configured to produce said first sound when said second tension measurement is less than said first tension measurement.

2. The animal training device of claim 1, wherein there is a time delay between said second tension measurement and when said sound generator produces said first sound.

3. The animal training device of claim 1,
wherein said tension measurement device is configured to take an intermediate tension measurement at a time before said second tension measurement but after said first tension measurement; and,
wherein said sound generator produces said first sound only if both said intermediate tension measurement and said second tension measurement are less than said first tension measurement.

4. The animal training device of claim 1, further comprising:
a first threshold tension level; and,
wherein said sound generator produces the first sound if said second tension measurement is below the first threshold tension level.

5. The animal training device of claim 4, wherein said first threshold tension level is adjustable.

6. The animal training device of claim 5, wherein said tension measurement device is configured to be programmable so that a user may adjust said first threshold tension level.

7. The animal training device of claim 5, wherein said threshold tension level automatically adjusts based on several tension measurements from said tension measurement device.

8. The animal training device of claim 7, wherein said threshold tension level is automatically adjusted based on a peak tension measured by said tension measurement device.

9. The animal training device of claim 4, wherein said second tension measurement must remain below the first threshold tension level for a determined amount of time before said sound generator produces the first sound.

10. The animal training device of claim 1 in which the sound generator produces said first sound for only between 0.1 and 10 seconds.

11. The animal training device of claim 10 in which the first sound produced includes speech.

12. The animal training device of claim 11 in which said speech is a recording of a person's voice.

13. The animal training device of claim 12 which comprises wireless technology to receive the recording of a person's voice.

14. The animal training device of claim 1,
wherein said sound generator is able to produce a second sound; and,
wherein said sound generator is configured to produce said second sound when said second tension measurement is greater than said first tension measurement.

15. The animal training device of claim 14, further comprising:
a second threshold tension level; and,
wherein said sound generator produces the second sound if said second tension measurement is greater than the second threshold tension level.

16. The animal training device of claim 15, wherein said second threshold tension level is adjustable.

17. The animal training device of claim 16, wherein said second threshold tension level is adjustable using a wireless connection to a personal computer, smartphone, or tablet.

18. The animal training device of claim 16, wherein said tension measurement device is configured to be programmable so that a user may adjust said second threshold tension level.

19. The animal training device of claim 15, wherein said second tension measurement must remain above the second threshold tension level for a determined amount of time before said sound generator produces the second sound.

20. The animal training device of claim 17, wherein the determined amount of time is adjustable.

21. The animal training device of claim 13, further comprising
a first threshold tension level;
a second threshold tension level at a tension that is larger than said first threshold tension level;
wherein when said second tension measurement must be below said first threshold tension level for said sound generator to produce said first sound; and,
wherein when said second tension measurement must be above said second threshold tension level for said sound generator to produce said second sound.

22. The animal training device of claim 21, wherein said second tension measurement must remain below said first threshold tension level for a determined amount of time before said sound generator produces said first sound.

23. The animal training device of claim 21, wherein said second tension measurement must remain above said second threshold tension level for a determined amount of time before said sound generator produces said second sound.

24. The animal training device of claim 14,
wherein said tension measurement device is configured to take an intermediate tension measurement at a time before said second tension measurement but after said first tension measurement; and,
wherein said sound generator produces said second sound only if both said intermediate tension measurement and said second tension measurement are greater than said first tension measurement.

25. The animal training device of claim 1, wherein said tension measurement device is positioned between said leash and the animal.

26. The animal training device of claim 1, wherein said tension measurement device is integral with the leash.

27. The animal training device of claim 1, wherein said tension measurement device is integral with a collar.

28. The animal training device of claim 1, wherein said first sound is a positive sound.

29. The animal training device of claim 14, wherein said second sound is a negative sound.
